(19) United States
(12) Patent Application Publication
(10) Pub. No.: US 2010/0274619 A1
(43) Pub. Date: Oct. 28, 2010

(54) Enhanced Calendaring Notification

(75) Inventors: Mark Edmund Maresh, Bath, MI (US); Eric Allen Stegner, Durham, NC (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/429,701

(22) Filed: Apr. 24, 2009

(51) Int. Cl. G06Q 10/00; G06F 15/16

(52) U.S. Cl. 705/9; 709/206

(57) ABSTRACT

One or more illustrative embodiments provide a method, system, and a computer program product for configuring groups in an electronic calendaring system. In one illustrative embodiment, a group in a distribution group is created, wherein the group comprises a number of members and the distribution group is stored in a memory. A number of notification options are set for the group in the distribution group. A number of groups from the distribution group are added to an invitee list for a calendar event, wherein each group in the number of groups is user-selected. A calendar event is sent to the number of groups. A set of conditions corresponding to the number of notification options is monitored. In response to a condition, from the set of conditions, occurring, sending a notification.

### BACKGROUND

1. Field

The present disclosure relates generally to an improved data processing and in particular to calendaring system. Still more particularly, the present disclosure relates to a method and apparatus for controlling notification options when scheduling calendar events.

2. Description of the Related Art

Calendaring systems, in the simplest form, help users to organize their time. Additionally, calendaring systems may be used to schedule team meetings, appointments, or other type of calendar events. Currently available calendaring systems allow a user to send electronic mail (e-mail) messages to recipients, wherein the e-mail messages pertain to a calendar event. When a user composes an e-mail message, the user specifies one or more recipients. Recipients may be individuals or groups. The recipients are placed in one of three standard invitee fields such as Required (to), Optional (cc), and FYI (bcc). Typically, primary recipients are placed in the Required field and secondary recipients are placed in the Optional and FYI fields. Primary recipients included in the Required field are generally more essential to a discussion. On the other hand, secondary recipients in the Optional and FYI fields may not be essential to a discussion and simply receive the e-mail message as a courtesy or notification.

When composing an e-mail, a user may choose a number of notification options. Examples of notification options are “return receipt,” “I do not want to receive replies from participants,” and “delivery report only on failure.” The notification options selected for the calendar event applies to all recipients without exception. In practice, a user may request a return receipt. Using this scenario, a return receipt is received by the user for each recipient included in the original calendar event.

### SUMMARY

One or more illustrative embodiments provide a method, apparatus, and a computer program product for configuring groups in an electronic calendaring system. In one illustrative embodiment, a group in a distribution group is created, wherein the group comprises a number of members and the distribution group is stored in a memory. A number of notification options are set for the group in the distribution group. A number of groups from the distribution group are added to an invitee list for a calendar event, wherein each group in the number of groups is user-selected. A calendar event is sent to the number of groups. A set of conditions corresponding to the number of notification options is monitored. In response to a condition from the set of conditions occurring, sending a notification.

### BRIEF DESCRIPTION OF THE SEVERAL VIEWS OF THE DRAWINGS

FIG. 1 is a pictorial representation of a network of data processing systems in which an illustrative embodiment may be implemented;

FIG. 2 is a block diagram of a data processing system in which an illustrative embodiment may be implemented;

FIG. 3 is a block diagram of a calendaring system, in accordance with an illustrative embodiment;

FIG. 4 is a block diagram of components of a data structure, in accordance with an illustrative embodiment;

FIG. 5 is a block diagram of components of a data structure, in accordance with an illustrative embodiment;

FIG. 6 is a block diagram of components of a data structure, in accordance with an illustrative embodiment;

FIG. 7 is a block diagram of components of a data structure, in accordance with an illustrative embodiment;

FIG. 8 is a block diagram of components of a data structure, in accordance with an illustrative embodiment;

FIG. 9 is a block diagram of components of a data structure, in accordance with an illustrative embodiment;

FIG. 10 is an illustration of an invitees list, present in a graphical user interface, in accordance with an illustrative embodiment;

FIG. 11 is an illustration of an invitees list, present in a graphical user interface, in accordance with an illustrative embodiment;

FIG. 12 is an illustration of a group configuration, present in a graphical user interface, in accordance with an illustrative embodiment;

FIG. 13 is an illustration of a individual configuration, present in a graphical user interface, in accordance with an illustrative embodiment;

FIG. 14 is a flowchart of a group configuration in an electronic mail message, in accordance with an illustrative embodiment;

FIG. 15 is a flowchart of a group configuration in an electronic mail message, in accordance with an illustrative embodiment; and

FIG. 16 is a flowchart for sending a notification in a calendaring system, in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

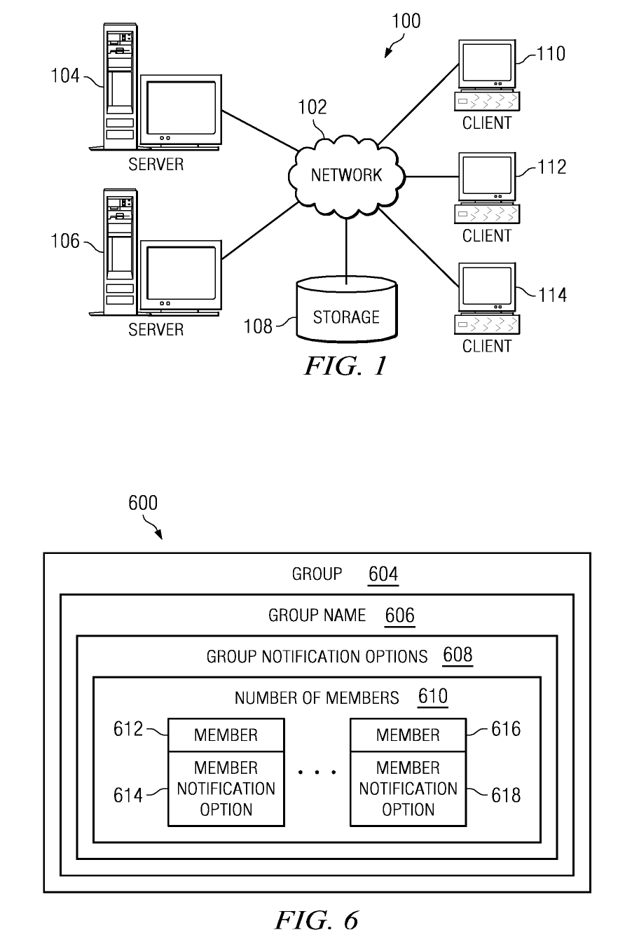

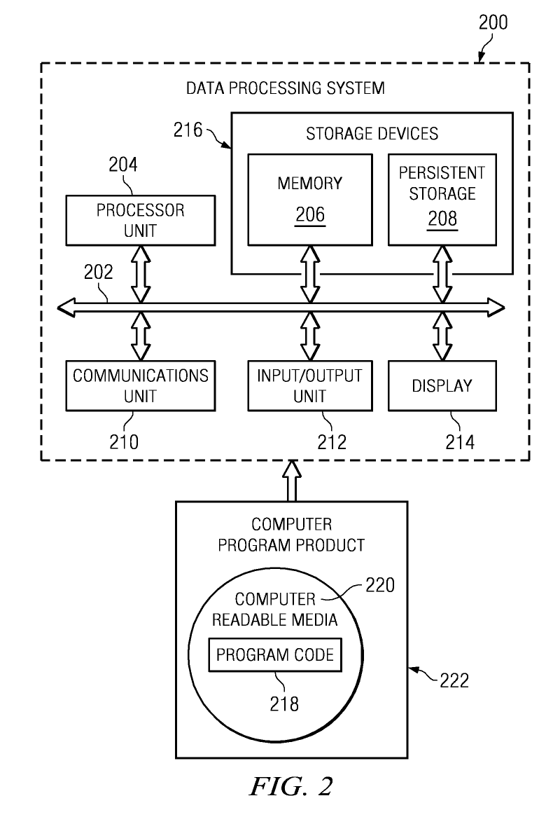

With reference now to the figures and in particular with reference to FIGS. 1-2, exemplary diagrams of data processing environments are provided in which an illustrative embodiment may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which an illustrative embodiment may be implemented. Network data processing system 100 is a network of computers in which an illustrative embodiment may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

In one example, a user of client 110 may want to communicate with a user of client 112 using electronic mail (email) by means of server 104. The user of client 110 may invoke a client calendar process on client 110 to compose an email message indicating one or more recipients. Additionally, client calendar process on client 110 may provide notification options allowing the user to specify notification options. Notification options may include, but are not limited too, a return receipt, I do not want to receive replies from participants, notification if no response, and resend if no response. After the user has sent the email, server 104 enforces the selected notification options.

Turning now to FIG. 2, a block diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instruction are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The different illustrative embodiments recognize and take into account a number of considerations. For example, the different illustrative embodiments recognized that currently available calendaring systems do not always provide a desired amount of flexibility in customizing notification options that pertain to a calendar event. Notification options are delivery options that provide control over the type of feedback received from invitees. Examples of notification options are “return receipt,” “I do not want to receive replies from participants,” and “delivery report only on failure.” Calendaring systems have standard invitee fields such as Required (to), Optional (cc), and FYI (bcc) to input invitee names. Invitees must be placed into one of three types of fields. Regardless of which invitee field a invitee has been placed, the calendaring system has limited “all” or “nothing” notification options. The notification options selected for the calendar event applies to all invitees. Notification options in currently available notification systems for calendaring appointments are not flexible.

Thus, the illustrative embodiments provide a method, apparatus, and computer program product for generating notifications in an electronic calendaring system. In one illustrative embodiment, a group in a distribution group is created, wherein the group comprises a number of invitees and the distribution group is stored in a memory. A number of notification options are selected for the group in the distribution group. A number of groups from the distribution group are added to an invitee list for a calendar event, wherein each group in the number of groups is user-selected. A calendar event is sent to the number of groups. A set of conditions corresponding to the number of notification options is monitored. In response to a condition from the set of conditions occurring, sending a notification.

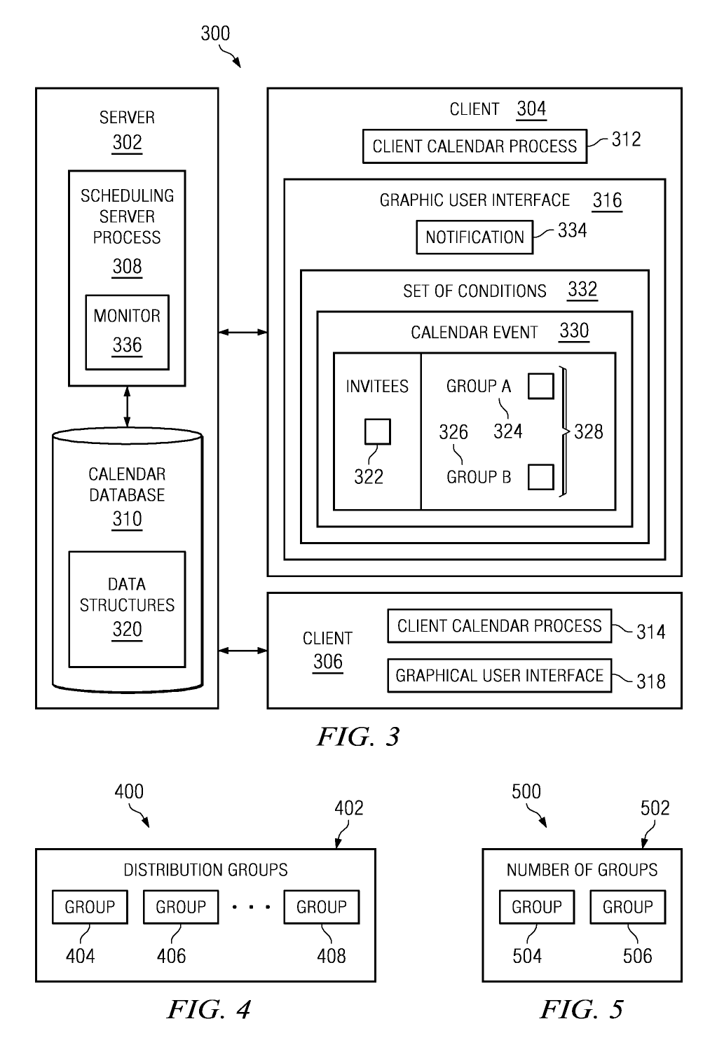

FIG. 3 illustrates a block diagram of a calendaring system, in accordance with an illustrative embodiment. In illustrative examples, calendaring system 300 may implement a number of illustrative embodiments that provide for controlling notification options when scheduling calendar appointments within calendaring system 300. In one illustrative example, network data processing system 100 implements calendaring system 300.

As depicted, calendaring system 300 includes server 302 and clients 304 and 306. Server 302 is an example of server 104 or server 106 in FIG. 1. Clients 304 and 306 are examples of clients 110, 112, and 114 in FIG. 1. Server 302 and clients 304 and 306 are illustrative as to the number of servers and clients that may be present in calendaring system 300 and should not be construed as an architectural limitation. Server 302 executes scheduling server process 308. Scheduling server process 308 may be a software component running on server 302. The depiction of one server should not be construed as an architectural limitation. Scheduling server process 308 may monitor for a set of conditions 332 corresponding to a calendar event 330. Responsive to monitor 336 detecting a condition in the set of conditions 332, scheduling server process 308 sends a notification 334. Calendar database 310 may be stored on server 302 and accessed by scheduling server process 308. Calendar database 310 may be used to maintain an association between scheduling server process 308 and client calendar processes 312 and 314. Client 304 contains client calendar process 312, and client 306 contains client calendar process 314.

As shown in FIG. 3, a composer of a calendar event may use client calendar process 312 to compose a calendar event with any number of invitees chosen from invitees menu button 322 viewed through graphical user interface 316. As shown, group A 324 and group B 326 have been chosen. Additional groups may be selected from invitees menu button 322. The notification options for each group may be changed by selecting the respective group configuration menu 328. If the notification options are configured to the user's needs, the user may fill out the rest of the calendar event information and send the calendar event notice to both group A 324 and group B 326. Client 306 may represent a member of either group A 324 or group B 326. Server 302 may then monitor for a set of conditions corresponding to the selected notification options. If the set of conditions occurs, server 302 sends a notification to client 304.

The illustration of calendaring system 300 in FIG. 3 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, scheduling server process 308 may be located on server 302 or spread across more than one server. Server 302 is shown as servicing clients 304 and 306 however, it should be appreciated that each client 304 and 306 may have one or more of its own servers. Although client 304 is depicted as sending email through graphical user interface 316, client 304 may also receive email from server 302. Likewise, although client 306 is depicted as receiving email from server 302, client 306 may also send email.

FIG. 4 illustrates a block diagram of components of a data structure, in accordance with an illustrative embodiment. For example, Data structure 400 may be stored in calendar database 310 in FIG. 3. Data structure 400 includes a distribution group 402. Distribution group 402 consists of group 404, 406, and 408. A group, such as group 404, 406, and 408, may be defined as an entity that contains one or more members and is configurable. A group is configurable because the configuration of the group may be changed according to user needs. For example, the group configuration may change when notification options are altered. Likewise, the group configuration may change when members (or invitees) are added or removed. A group configuration is user defined. Group 404, 406, and 408 are illustrative as to the number of groups that may be present in the distribution group 402 and should not be construed as an architectural limitation. Standard invitee fields such as Required (to), Optional (cc), and FYI (bcc) may be replaced with one or more groups in the distribution group 402.

FIG. 5 illustrates a block diagram of components of a data structure, in accordance with an illustrative embodiment. Data structure 500 includes a number of groups 502. A number of groups as used herein means one or more groups. Number of groups 502 consists of group 504 and 506. Each group in the number of groups 502 is user-selected from the distribution group 402. Group 504 and 506 are illustrative as to the quantity of groups that may be present in the number of groups 502 and should not be construed as an architectural limitation.

FIG. 6 illustrates a block diagram of components of a data structure, in accordance with an illustrative embodiment. Data structure 600 includes group 604. Group 604 is a detailed example of group 404 in FIG. 4. Group 604 may be any user defined group. In these examples, group 404 may be selected through user input. For example, group 604 may represent a project team, department, or special committee. Group 604 includes group name 606 and group notification options 608. Group 604 further includes a number of members 610. A number of members as used herein means one or more members. The user may customize the number of members 610 for each group. The number of members 610 consists of member 612 and 616. Member 612 and 616 are illustrative as to the number of members that may be present in the number of members 610 and should not be construed as an architectural limitation. Each member in the number of members 610 has a member notification option. For example, member 612 has member notification option 614.

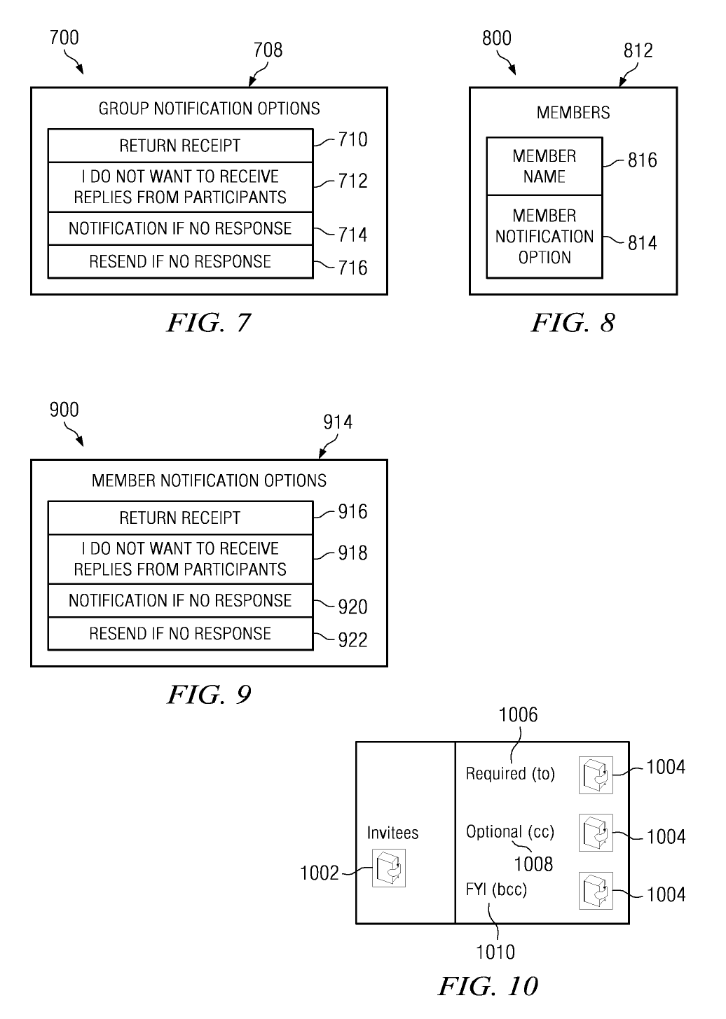

FIG. 7 illustrates a block diagram of components of a data structure, in accordance with an illustrative embodiment. Data structure 700 includes group notification options 708. Group notification options 708 is an example of group notification options 608 in FIG. 6. Group notifications options 708 may include, but is not limited too, the options of return receipt 710, I do not want to receive replies from participants 712, notification if no response 714, and resend if no response 716.

FIG. 8 illustrates a block diagram of components of a data structure, in accordance with an illustrative embodiment. Data structure 800 includes member 812. Member 812 is an example of member 612 in FIG. 6. Member 812 includes member name 816 and member notification option 814. Member notification option 814 is an example of member notification option 614.

FIG. 9 illustrates a block diagram of components of a data structure, in accordance with an illustrative embodiment. Data structure 900 includes member notification options 914. Member notification options 914 corresponds to member notification options 614 in FIG. 6 and member notification options 814 in FIG. 8. Member notification options 914 includes, but is not limited too, a return receipt 916, I do not want to receive replies from participants 918, notification if no response 920, and resend if no response 922.

The illustration of the data structures in FIG. 4-9 are not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiment.

For example, the distribution group 402 may contain any number of groups. Distribution group 402 may also be empty such that a group needs to be created. Additionally, group notification options 708 and member notification options 914 may contain additional options not shown. Furthermore, member 812 may simultaneously belong to more than one group.

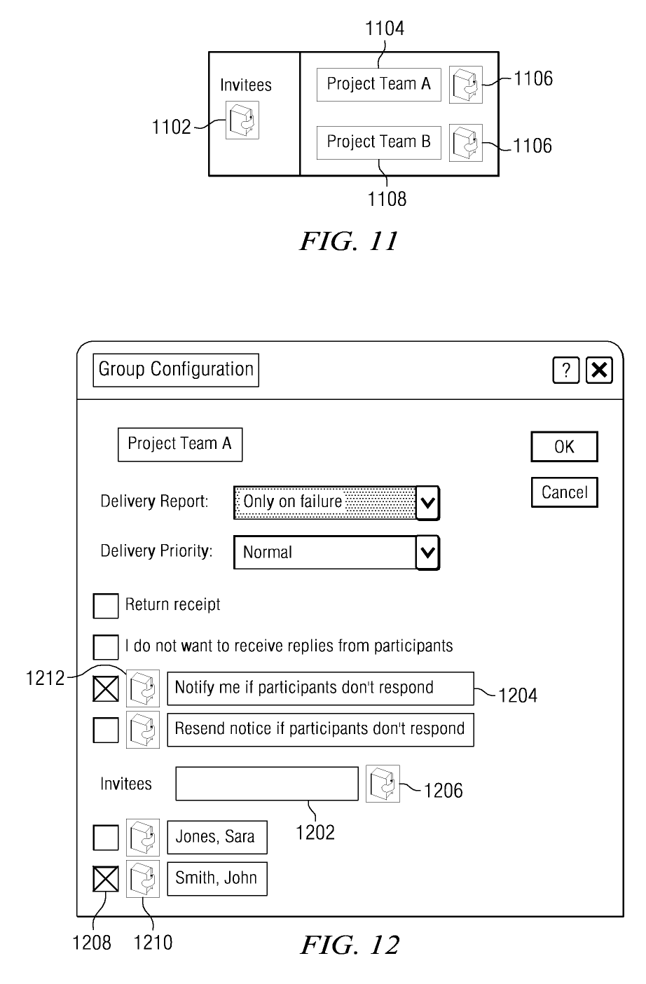

FIG. 10 is an illustration of an invitees list present in a graphical user interface, in accordance with an illustrative embodiment. For example, FIG. 10 may be displayed on graphical user interface 316 in FIG. 3. FIG. 10 depicts an example of a default set of invitee groups 1004 called Required 1006, Optional 1008, and FYI 1010. The default set of invitee groups 1004 may have a similar look to currently available calendaring systems, however it should be noted that FIG. 10 depicts invitee groups and not invitee fields. The invitee groups are controlled by menu button 1002. Invitee groups may be added or removed by selecting menu button 1002. To add or remove individuals from the groups, or to change the configuration of the group, menu button 1004 may be selected. Although not shown, an invitee input field may also be added to FIG. 10. FIG. 11 is an illustration of an invitees list present in a graphical user interface, in accordance with an illustrative embodiment. For example, FIG. 11 may be displayed on graphical user interface 316 in FIG. 3. FIG. 11 illustrates an example of using two preset groups, Project Team A 1104 and Project Team B 1108. If a user communicates with a project team, the user could create groups called Project Team A 1104, and Project Team B 1108. The members of Project Team A 1104 and B 1108 could be invited to the same calendar event by selecting Project Team A 1104 and Project Team B 1108 from the invitees menu button 1102. The user, however, may require different feedback from each group. For example, the user may want confirmation that members of Project Team A 1104 plan on attending, whereas the user may not want any feedback from the members of Project Team B 1108. If Project Team A 1104 and Project Team B 1108 are pre-configured to the user's needs, then the user could fill out the rest of the calendar event information, such as date, time, subject, attachments, etc. and send the calendar event notice to both Project Team A 1104 and Project Team B 1108. To change the configuration of Project Team A 1104 and Project Team B 1108 before sending the calendar event notice, the user may select menu button 1106. Selecting menu button 1106 would display a group configuration menu as shown in FIG. 12.

FIG. 12 illustrates an illustration of a group configuration present in a graphical user interface, in accordance with an illustrative embodiment. For example, FIG. 12 may be displayed on graphical user interface 316 in FIG. 3. FIG. 12 illustrates a group configuration menu that allows a user to set notification options for a particular group. In this example the check box 1204 for “Notify me if participants don't respond” is checked. Check box 1204 may be already checked as a default feature. Unchecking check box 1204 changes the default feature. A default time for the Notify me if participants don't respond option may be set by selecting the menu button 1212 for Notify me if participants don't respond. For example, the default time could be set such that a notification is sent one day before the calendar event. The default time may be changed to any time before the calendar event.

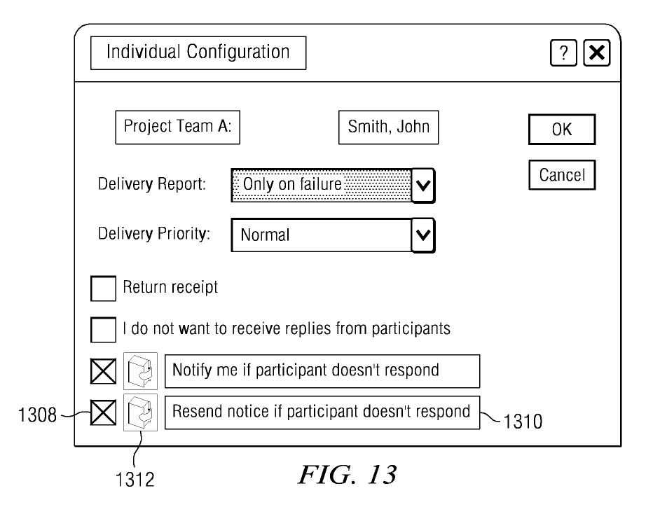

Members may be added to the group by entering the member into the group invitee list 1202 or by using the address book function 1206. Group members are displayed. Each group member may be individually configured within the group configuration such that each member may have a unique configuration. Checking a box next to the member name indicates that the individual configuration takes precedence over the group configuration. To change individual configurations, a menu button next to the member name may be selected. Referencing FIG. 12, there is a check 1208 and menu button 1210 next to John Smiths name. The check 1208 indicates that the individual configuration for John Smith takes precedence over the group configuration. The menu button 1210, if selected, displays John Smith's individual configuration which is further discussed in FIG. 13.

FIG. 13 illustrates an illustration of an individual configuration present in a graphical user interface, in accordance with an illustrative embodiment. For example, FIG. 13 may be displayed on graphical user interface 316 in FIG. 3. FIG. 13 illustrates the individual configuration for John Smith as menu button 1210 indicates in FIG. 12. If John Smith is critical to attend the calendar event, the user would select the check box 1308 next to the “resend notice if participant doesn't respond” 1310. This feature can be configured to change the time before the calendar event to resend the notice by selecting the menu button 1312. Changes made inside the individual configuration menu do not affect the group configuration settings (FIG. 12).

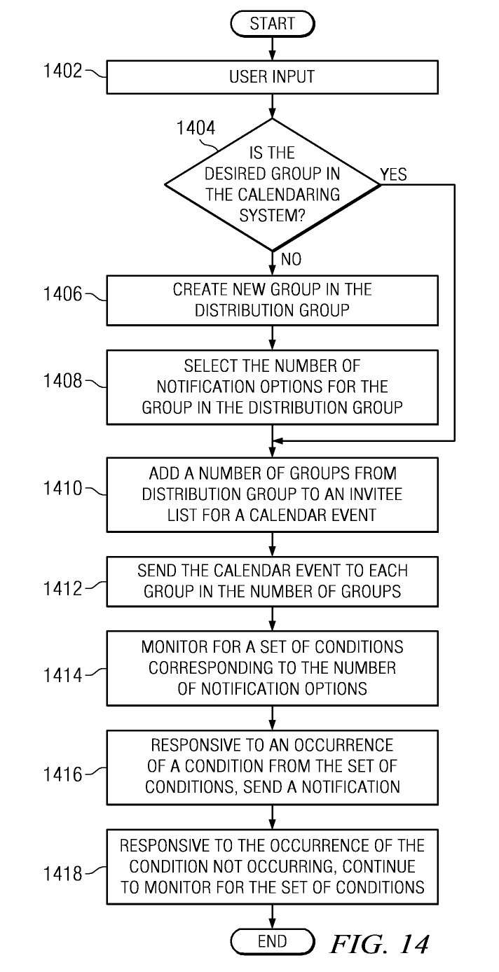

FIG. 14 illustrates a flowchart of a group configuration in an electronic mail message, in accordance with an illustrative embodiment. The process in FIG. 14 may be implemented as a software component, such as scheduling server process 308 in FIG. 3. The process begins by receiving a user input (step 1402). Responsive to receiving a user input, determining whether the desired group is in the calendaring system (step 1404). If the desired group is not in the calendaring system, a group in a distribution group is created, wherein the group comprises a number of invitees (step 1406). A distribution group as used herein means one or more groups. A number of invitees as used herein means one or more invitees. A number of notification options for the group in the distribution group is selected (step 1408). A number of notification options as used herein means one or more notification options. Selecting a number of notification options for the group corresponds to FIG. 12. FIG. 12 illustrates a group configuration menu that allows a user to set notification options for a particular group. For example, notification options may be “return receipt,” “I do not want to receive replies from participants,” “notify me if participants don't respond,” and “resend notice if participants don't respond.” When the desired group is in the calendaring system, adding a number of groups from the distribution group to an invitee list for a calendar event, wherein each group in the number of groups is user-selected (step 1410). Sending the calendar event to the number of groups (step 1412). Monitoring for a set of conditions corresponding to the number of notification options (step 1414). In response to a condition from the set of conditions occurring, sending a notification (step 1416). If the condition has not occurred, continuing to monitor for the set of conditions (step 1418) with the process terminating thereafter.

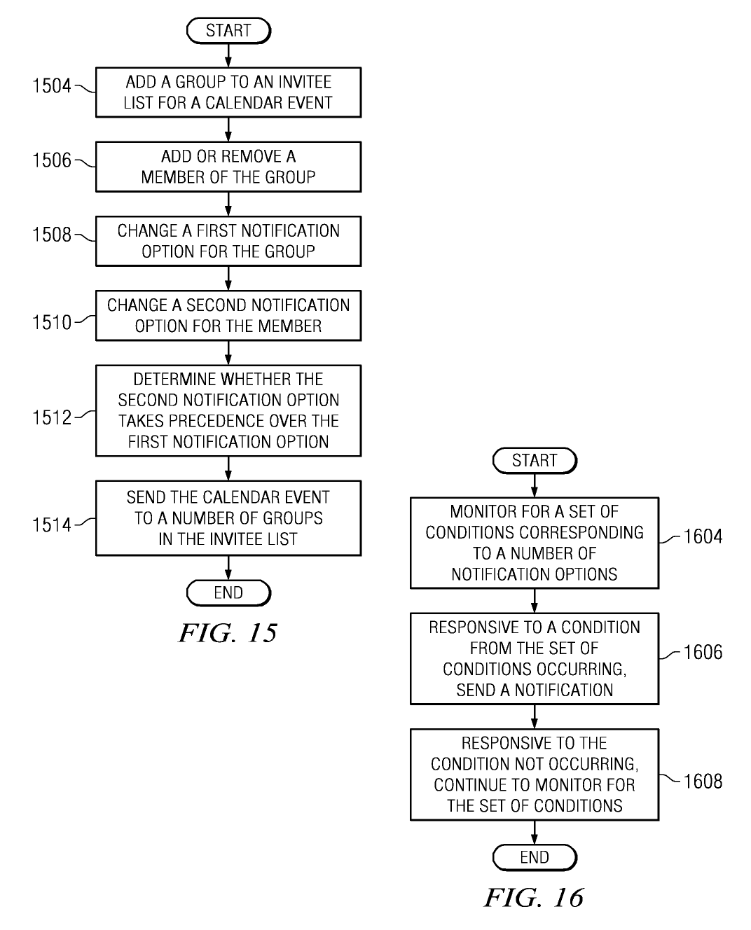

FIG. 15 is a flowchart of a group configuration in an electronic mail message, in accordance with an illustrative embodiment. The process in FIG. 15 may be implemented as a software component, such as client calendar process 312 in FIG. 3. A group is added to an invitee list for a calendar event (step 1504). A member is then added or removed from the group (step 1506). A first notification option for the group is changed (step 1508). A second notification option for the member is changed (step 1510). A determination is made as to whether the second notification option takes precedence over the first notification option (step 1512). The calendar event is sent to a number of groups in the invitee list (step 1514).

FIG. 16 is a flowchart for sending a notification in a calendaring system, in accordance with an illustrative embodiment. The process in FIG. 16 may be implemented as a software component, such as scheduling server process 308 in FIG. 3. The process begins by monitoring for a set of conditions corresponding to the number of notification options (step 1604). In response to a condition from the set of conditions occurring, sending a notification (step 1606). If the condition has not occurred, continuing to monitor for the set of conditions (step 1608) with the process terminating thereafter.

One or more illustrative embodiments provide a method, apparatus, and a computer program product for configuring groups in an electronic calendaring system thereby enhancing the control the calendaring system user has over the feedback received in response to a calendar event. Creating groups which are configurable enables a user to define notification options according to a group rather than an invitee field thereby reducing user effort in scheduling meetings. Defining notification options according to group and group members reduces storage space and bandwidth activity because unnecessary notifications are avoided.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing notifications in a calendaring system, the method comprising:
responsive to a user input, creating a group in a distribution group, wherein the group comprises a number of members and the distribution group is stored in a storage device;
selecting a number of notification options for the group in the distribution group;
adding a number of groups from the distribution group to an invitee list for a calendar event, wherein each group in the number of groups is user-selected;
sending the calendar event to each group in the number of groups;
monitoring for a set of conditions corresponding to the number of notification options; and
responsive to an occurrence of a condition from the set of conditions, sending a notification.

2. The method of claim 1, wherein the number of notification options is a first number of notification options, further comprising:
modifying a second number of notification options for a member of the group.

3. The method of claim 2, wherein the second number of notification options takes precedence over the first number of notification options.

4. The method of claim 1, wherein the number of notification options further comprises:
a notification if no response and a resend if no response.

5. The method of claim 2, wherein a notification if no response and a resend if no response is sent a specified time before the calendar event.

6. The method of claim 1, wherein adding a number of groups from the distribution group, further comprises:
modifying the number of notification options for the group in the distribution group.

7. The method of claim 1, wherein sending the notification further comprises:
sending the notification a specified time before the calendar event.

8. A computer program product comprising:
a computer readable storage medium having a computer usable program code for a calendaring system, the computer usable program code executable by a processor of a computer to cause a processor to perform steps comprising:
responsive to a user input, creating a group in a distribution group, wherein the group comprises a number of members and the distribution group is stored in a memory;
selecting a number of notification options for the group in the distribution group;
adding a number of groups from the distribution group to an invitee list for a calendar event, wherein each group in the number of groups is user-selected;
sending the calendar event to each group in the number of groups;
monitoring for a set of conditions corresponding to the number of notification options; and
responsive to an occurrence of a condition from the set of conditions, sending a notification.

9. The computer program product of claim 8, wherein the number of notification options is a first number of notification options, further comprising:
modifying a second number of notification options for a member of the group.

10. The computer program product of claim 9, wherein the second number of notification options takes precedence over the first number of notification options.

11. The computer program product of claim 8, wherein the number of notification options further comprises:
a notification if no response and a resend if no response.

12. The computer program product of claim 8, wherein a notification if no response and a resend if no response is sent a specified time before the calendar event.

13. The computer program product of claim 8, wherein adding a number of groups from the distribution group, further comprises:
modifying the number of notification options for the group in the distribution group.

14. The computer program product of claim 8, wherein sending the notification further comprises:
sending the notification a specified time before the calendar event.

15. A calendaring system, comprising:
a bus system;
a number of storage devices connected to the bus system, wherein the number of storage devices includes program code; and
a processor unit connected to the bus system, wherein the processor unit executes the program code to create a group in a distribution group, wherein the group comprises a number of members, responsive to user input; select a number of notification options for the group in the distribution group; add a number of groups from the distribution group to an invitee list for a calendar event, wherein each group in the number of groups is user-selected; send the calendar event to each group in the number of groups; monitor for a set of conditions corresponding to the number of notification options; and send a notification responsive to an occurrence of a condition from the set of conditions.

16. The calendaring system of claim 15, wherein the processor unit further executes the program code to modify a second number of notification options for a member of the group, wherein the number of notification options is a first number of notification options.

17. The calendaring system of claim 16, wherein the processor unit further executes the program code, wherein the second number of notification options takes precedence over the first number of notification options.

18. The calendaring system of claim 15, wherein the processor unit further executes the program code, wherein the number of notification options further comprises:
a notification if no response and a resend if no response.

19. The calendaring system of claim 18, wherein a notification if no response and a resend if no response is sent a specified time before the calendar event.

20. The calendaring system of claim 15, wherein the processor unit further executes the program code, wherein adding a number of groups from the distribution group, further comprises:
modifying the number of notification options for the group in the distribution group.
